(19) United States
(12) Patent Application Publication
(10) Pub. No.: US 2021/0072388 A1
(43) Pub. Date: Mar. 11, 2021

(54) OPTOELECTRONIC SENSOR AND METHOD OF DETECTING OBJECTS IN A MONITORED ZONE

(71) Applicant: SICK AG, Waldkirch (DE)

(72) Inventors: Christoph MENZEL, Waldkirch (DE); Siegfried RINGWALD, Waldkirch (DE)

(21) Appl. No.: 17/015,921

(22) Filed: Sep. 9, 2020

(30) Foreign Application Priority Data
Sep. 10, 2019 (DE) 102019124266.5

(51) Int. Cl. G01S 17/48; G01S 17/04

(52) U.S. Cl. CPC G01S 17/48; G01S 17/04

(57) ABSTRACT

An optoelectronic sensor for detecting objects in a monitored zone that has a light receiver having a reception optics arranged in front of it for generating a received signal from received light that impinges the sensor in a direction of incidence of light from the monitored zone, wherein the reception optics comprises a flat light guide plate having a first main surface and a lateral edge bounding the first main surface at a side; wherein the first main surface of the light guide plate is arranged transversely to the direction of incidence of light and has a diffractive structure to deflect the incident received light to the lateral edge; and wherein a control and evaluation unit is provided to evaluate the received signal.

The invention relates to an optoelectronic sensor, in particular a light barrier or a light sensor, for detecting objects in a monitored zone that has a light receiver having a reception optics and to a method of detecting objects in a monitored zone.

As a rule, optoelectronic sensors use a receiver lens to focus the light to be detected on their light receiver. Such receiver lenses have a certain construction size and focal length and a defined distance between the receiver lens and the light receiver results from this.

To achieve large ranges with a sensor, as much useful light as possible should be collected and the reception aperture should therefore be large. A large reception opening is, however, necessarily accompanied by a large construction depth. It can approximately be assumed that the diameter of the reception aperture corresponds to the required construction depth for the reception lens and the light receiver. This relationship can also not be broken up by a classical reception optics for which a large reception aperture with a very small focal length combined in one element makes contradictory demands.

Large reception apertures therefore mean a large construction depth and thus a large sensor construction shape. Small construction shapes, in particular small construction depths, cannot be equipped with a reception optics of a larger reception aperture for considerably increased ranges. Particularly with simple sensors such as miniature light barriers, however, a minimal construction depth of only a few millimeters is available for the optics, electronics, and mechanical components. With a sensor that is 3.5 mm narrow, for example, after deduction of housing walls, a circuit board, and electronic elements, just 1.5 mm is still available for the reception optics. An aperture of not substantially more than 1.5 mm is then possible with a classical reception optics.

A widespread class of optoelectronic sensors measures a distance or at least takes the object distance into account in their evaluation. One of the measurement principles for this is optical triangulation that is based on arranging a light transmitter and a spatially resolving light receiver offset from one another by a known base distance. The transmission light beam and the reception light beam are then at an angle to one another, which has the result that the received light spot on the receiver migrates in dependence on the distance from the sensed object. The position of the received light spot on the spatially resolving light receiver is accordingly a measure for the object distance.

There are not only measuring triangulation sensors that determine and output a distance in the outlined manner, but also switching systems in accordance with the triangulation principle whose switching behavior depends on the object distance. These sensors include the background masking light sensors. They are switching, that is only output a binary object determination signal. At the same time, however, the design of a triangulation sensor is utilized to generate two reception signals using a light receiver spatially resolving at least into a near zone and a far zone. Their difference is evaluated with a switching threshold in order thus to restrict the object detection to a specific distance zone and to mask reception signals from objects outside this distance zone as a background signal. A background masking light sensor is disclosed, for example, in DE 197 21 105 C2, wherein here switches are provided to associate the individual elements of a spatially resolving light receiver with the near zone or far zone in a variable manner.

Such sensors operating in accordance with the triangulation principle also require a certain construction depth. A high sensitivity can only be achieved by a corresponding construction depth and that limits or prevents the use of such sensors in certain applications.

An optical system having a light-permeable flat light guide plate is known from DE 198 58 769 A1. In different embodiments, the received light radiating onto the flat side is directed to a light receiver through refractive sub-apertures, wedge surfaces, or layers of different refractive indices. This refractive arrangement, however, has only a small transmission efficiency and still results in a relatively large construction depth of a sensor equipped therewith of 5 to 10 mm.

An optoelectronic sensor is known from DE 10 2014 102 420 A1 whose reception optics has a diaphragm having an optical funnel element arranged downstream. The construction depth of the reception optics, however, thereby becomes even greater.

U.S. Pat. No. 5,268,985 deals with a light guiding device having a holographic layer that is embedded in a light permeable substrate. Light incident onto the holographic layer is laterally deflected at an angle and is then deflected to the side by the substrate with total reflection.

US 2006/0091305 A1 describes an optical phased array that has a cascade of Bragg gratings that each deflect a portion of the transmitted light, with the transmission light beam produced overall being shaped by phase shifters between the Bragg gratings. A use at the reception side using reversed beam paths is likewise possible.

EP 1 312 936 A2 discloses an optoelectronic apparatus for detecting objects. In an embodiment, a light guide plate is perpendicular to the direction of incidence of the received light. Two prism layers that deflect the received light transversely into the light guide plate are located above the main surface of the light guide plate. A deflection element is provided at the rear end of the light guide plate.

DE 600 01 647 T2 discloses a diffractive collector. A holographic grating is provided at its upper side and deflects incident light toward the edge where it is detected by photodetectors.

A light module for lettering that can be illuminated from behind is known from DE 20 2006 017 445 U1. Two LEDs irradiate light into a light guide plate from both sides. The lower side of the light module is a grid surface whose structure deflects the light into the lettering.

It is therefore the object of the invention to enable a more compact construction of an optoelectronic sensor.

This object is satisfied by an optoelectronic sensor and by a method of detecting objects in accordance with the respective independent claim. The sensor has a light receiver having a reception optics for received light that irradiates from a direction of incidence of light from the monitored zone. The reception optics comprises a flat light guide plate that is oriented in a planar manner with respect to the received light at which therefore a first main surface or flat side is transverse to the direction of incidence of light. The received light is then deflected in the direction of a lateral edge in the light guide plate. The light receiver is arranged at the lateral edge, with even further optical elements also being able to be provided between the lateral edge and the light receiver.

The light guide plate is provided with a diffractive structure. The light guide plate thus becomes a diffractive flat plate collector that collects received light with its first main surface and guides it to the lateral edge. The diffractive structure provides the deflection, that is the change of direction, of the received light from the direction of incidence of light in a direction substantially within the plane of the guide plate. The condition for total reflection is then satisfied afterward and the received light thus propagates within the plane of the light guide plate toward the lateral edge. Without the deflection, the condition for total reflection would not be sufficient transversely, in particular almost perpendicular to the first main surface, due to the direction of incidence of light, and the received light would simply exit the oppositely disposed second man surface again. The diffractive structure can be arranged at the first main surface and/or at the second main surface.

The invention starts from the basic idea of using a spatially resolving light receiver; that is in particular a plurality of discrete light reception elements such as photodiodes, a PDS (position sensitive device), or a receiver array or receiver matrix having a plurality of pixel-like light reception elements. A control and evaluation unit for evaluating the received signal or the received signals of the light receiver determines a piece of distance information from the point of impingement of the received light on the light receiver. It can be a measured value for the distance, but can also only indirectly enter into the evaluation as in the case of a distance class or the like to mask far objects, for example.

With a conventional collector, the receiver light is only collected and is converted into a received signal by a simple light reception element. Any information such as point of impingement or an angle of incidence that could be used for a distance measurement similar to triangulation is lost in this process. In accordance with the invention, in contrast, one or more light guide plates are configured, arranged, and used such that a piece of distance information can nevertheless be acquired using a spatially resolving light receiver and can be taken into account in the evaluation.

The invention has the advantage that the connection of a reception optics having a small construction depth and a large aperture is made possible by the reception optics having the diffractive flat plate collector, and indeed with a construction depth that can even be very small with respect to the reception aperture since the surface taken up by the light guide plate can be very large. The reception optics only has a relatively small acceptance angle that is determined by the angular selectivity of the diffractive structure and by the critical angle of the total reflection in the light guide plate. Received light of too oblique an incidence is therefore not deflected and is forwarded on in total reflection. This produces a lateral field of vision restriction or a kind of diaphragm effect that is, however, only advantageous with a sensor aligned to a useful light source. The invention makes it possible to carry out a distance measurement or a background masking with reference to the angle of incidence despite the narrow acceptance angle and thus also to use the advantageous flat construction principle having a diffractive flat plate collector with distance measuring sensors or sensors operating in accordance with a triangulation principle. The diffractive structure acts, in addition to its deflection function, as an optical bandpass filter that can be adapted to a known useful light source and so improves the signal-to-noise ratio with extraneous light. The manufacture of the reception optics is possible very inexpensively, particularly with high volumes, since a tool-bound method such as UV molding can be used in which mainly one-time costs arise for the tool itself.

The sensor is preferably configured as a background masking light sensor in which the light receiver has a near zone and a far zone and that has a switch output whose switching state depends on whether an object is detected in the near zone. A background masking light sensor divides the monitored zone into a foreground in which the detection of an object should be operated and a background to be masked. The deflection with foreground masking is naturally equally possible. The piece of distance information acquired from the received signal does not comprise a specific measured distance value in these embodiments, but rather the fact that an object is detected in a specific distance zone, i.e. in the near or far zone. This binary object determination signal is output as a switching signal. The functional principle of a background masking light sensor was briefly explained in the introduction.

The sensor is preferably configured as a triangulation sensor in which the control and evaluation unit measures the distance of the detected object from the point of impingement of the received light on the light receiver. A measured distance value is now acquired here in accordance with the principle of triangulation and is made available as a measured variable. The invention makes possible a previously unachievably flat manner of construction both for a background masking light sensor and for a triangulation sensor.

The sensor preferably has a light transmitter in a triangulation arrangement with respect to the light guide plate. Although received light from an extraneous or cooperatively arranged light source can generally also be measured, the sensor preferably uses its own light transmitter in a defined relative arrangement with respect to the light guide plate. It can thereby be ensured that a measurable triangulation angle whose parameters are known or calibrated is produced in dependence on the distance of the detected object. The position of the light transmitter depends on the specific design of the light transmitter. For example, the light transmitter is arranged next to the light guide plate or the light guide plates, but can also irradiate through an aperture in a light guide plate that is then preferably attached in a decentralized manner to generate the triangulation angles.

The diffractive structure preferably has a grating structure. A grating structure can be specified and generated on the light guide plate relatively simply. It is particularly preferably an echelette grating (blazed grating) that diffracts a large portion of the light energy irradiated inward in the desired spectrum in an order of magnitude that corresponds to the desired deflection. An echelette grating is consequently adapted to a useful light spectrum and there are only small light losses on the deflection of useful light to the lateral edge. An echelette grating accordingly has a limited acceptance angle range that is further reduced in combination with the light guide plate and because of which a varying angle of incidence that is indispensable for a triangulation thus does not appear compatible at first glance. The invention shows different options to nevertheless implement this.

The reception optics preferably has a plurality of flat light guide plates at whose lateral edges a respective light reception element of the light receiver is arranged. The previously described light guide plate is multiplied in an illustrative aspect, with at least the respective diffractive structure being able to undergo individual adaptations. The light guide plates continue to collect the received light impinging on them on a light reception element. The totality of the light reception elements, whether they be discrete photodiodes or regions of a common arrangement such as of a receiver array, form the spatially resolving light receiver since it is possible to distinguish which light guide plate has collected the respective light due to the identity of the respective light reception element. The arrangement of light reception elements at an edge relates to the optical effect, still further optical elements for deflection, concentration, and the like can be present between the edge and the light reception element.

The light guide plates are preferably arranged rotated with respect to one another with respect to a normal on their main surface. The main surfaces of the plurality of light guide plates are generally in parallel with one another, preferably all of the light guide plates in the same plane. The light guide plates are, however, rotated with respect to one another in this embodiment and the lateral edges onto which the received light is respectively deflected are thus not in parallel with one another. It must be mentioned as a precaution that an antiparallel arrangement is not understood as not parallel here. Due to the rotation, the diffractive structures of the different guide plates deflect the received light in different directions, namely in each case to the lateral edges not aligned in parallel with one another.

Two light guide plates are advantageously arranged rotated with respect to one another by 180° with respect to a normal on their main surface. This is a special case in which the two light guide plates are impinged by the incident received light at an angle of incidence of the same amount, but of a different sign. An associated light transmitter is preferably located on a center line between the light guide plates, but then not centrally on the center line, but laterally offset to generate a triangulation angle. The two light guide plates therefore generate different received signals because the coupling efficiency is also different with the same amount of the angle of incidence in dependence on the sign. For one sign, the coupling efficiency at an angle of incidence approaching the acceptance angle does not increase like a switch binarily from zero to a maximum, but a flat flank is rather formed. This is due to so-called double impingements that will be explained in the description of the Figures. A conclusion can in any case be drawn on the angle of incidence and thus on the distance of the detected object from the ratio of the two signals due to this asymmetry with respect to the sign of the angle of incidence.

The control and evaluation unit is preferably configured to determine the piece of distance information from a difference of the first received signal of the light reception element associated with the first light guide plate and of the second received signal of the light receiver element associated with the second light guide plate, in particular from the quotient of the difference and sum of the first received signal and the second received signal. It evaluates the ratio of the two received signals S1 and S2 of the two light guide plates named in the preceding paragraph, in this case as a difference S1−S2. There is preferably additionally a standardization to the total level (S1−S2)/(S1+S2).

The diffractive structures of the light guide plates are preferably configured to deflect respective received light having a direction of incidence of light of an acceptance angle range, with the acceptance angle ranges of the light guide plates differing. The acceptance angle ranges have already been addressed many times and are particularly selectively pronounced with a blazed grating or echelette grating. In this embodiment, a plurality of light guide plates having respectively different acceptance angles are now responsible for a specific triangulation angle range and thus distance range of the detected objects. The light guide plates are consequently configured differently as near and far elements or any desired number of elements for staggered distances.

The light receiver is preferably configured to determine the point of impingement of the received light at the lateral edge of a light guide plate, with in particular only one single light guide plate being provided. In the previously described embodiments, one respective light reception element was associated with one light guide plate that summarily collects the incident received light and generates a common received signal therefrom for this light guide plate. In this respect, it was irrelevant whether the lateral edge was specifically impinged or whether it was illuminated everywhere. In this embodiment, the point of impingement on the light guide plate is now already determined for one and the same light guide plate. A plurality of light reception elements or a PSD are/is associated with the same light guide plate for this purpose. A single light guide plate is then also already sufficient to measure distances in accordance with the triangulation principle. A kind of hybrid would, however, also be conceivable in which a plurality of light guide plates are distributed over the distance range to be covered in total, but distances are simultaneously triangulated by means of a spatially resolving detection of the point of impingement of the incident received light.

A diaphragm is preferably disposed in front of the main surface. The diaphragm is located in front of or also directly on the main surface. It provides that a light spot is produced that permits a distinction of the point of impingement on the spatially resolving light receiver.

The light receiver is preferably arranged with respect to the light guide plate such that the direction of incidence of light varies with the distance of the detected object at an angle transversely to the direction of the lateral edge. The normal on the main surface can be described in two angles θ, φ. The angle θ is here in a first plane in which the main surface and a perpendicular on the lateral edge are disposed, that is the main deflection direction. The angle φ is in a second plane perpendicular to the main surface and the first plane. In the previously described embodiments, the angle θ, with respect to which the acceptance angle of the diffractive structure is also defined, was used for this distance measurement. In this embodiment, the angle φ is now perpendicular thereto. The arrangement of the light transmitter accordingly has to be rotated with respect to the light guide plate. The diffractive structure acts so-to-say as a mirror in the φ direction. The angle φ acting as a triangulation angle here is therefore converted on the deflection by the diffractive structure to an angle δ as a deviation from a perpendicular impingement on the lateral edge. The angle δ then determines where the received light spot is incident on the lateral edge and thus on the spatially resolving light receiver arranged there. It must be added that the optical effect of the diffractive structure on the angle φ is admittedly similar to a mirror, but no comparably flat design of the sensor could be achieved with an actual mirror.

The light transmitter is preferably arranged with respect to the light guide plate such that the direction of incidence of light is in an acceptance angle range of the diffractive structure. With the angles defined in the previous paragraph, this means that care is not only taken that the angle φ varies with the distance of the detected object and that this can be measured by the spatially resolving light receiver. In addition, the diffractive structure should now also operate in its optimum range and have a high coupling efficiency for the varying φ over a broad φ range. This is the case when the other component θ of the angle of incidence corresponds as much as possible to the acceptance angle range, in particular when θ=0 applies. With an θ not well adapted to the acceptance angel range, the light yield is naturally smaller, which would, however, still be acceptable for certain angle differences. However, in this process the useful φ range drops dramatically and θ should therefore preferably correspond as ideally as possible to the designed acceptance angle of the diffractive structure.

The reception optics preferably has a funnel element arranged at the lateral edge of a respective light guide plate. The funnel element, also called a tapered element or simply a taper, has a cross-section that corresponds to the lateral edge and that tapers toward the light exit side. The light receiver or its light reception element is arranged at the light exit side, with still further optical elements being able to be present therebetween. With the combination of light guide plate and funnel element, the reception optics is configured as a diffractive flat plate collector having a refractively tapered optics.

The funnel element is preferably of a flat design and its surface direction is aligned in the extension of the main surface. The funnel element thus directly adjoins the light guide plate and continues the main surface, with a certain angle out of the plane of the main surface being conceivable. The received light is concentrated in both cross-sectional directions outside the funnel element. In the one axis perpendicular to the main surface and to the funnel element, the diffractive structure and the usually multiple total reflection within the plane of the main surface of the flat light guide plate provide this. The cross-section of the received light is therefore only as high as the small thickness of the light guide plate. The funnel element tapers in the second axis along the lateral edge and thus provides the concentration.

The light guide plate and the funnel element are preferably formed in one piece. This produces a particularly simple design. The funnel element thus not only optically continues the light guide plate, but also forms a common element.

The funnel element preferably has a non-linear taper. The concentration effect can thereby be further improved or a shorter length of the funnel element is made possible. A linear taper would mean that the funnel element represents a trapezoid in the plan view in parallel with the direction of incidence of light. Non-linear is, for example, a parabolic shape or any desired free-form shape in which, however, the lateral flanks face monotonically inwardly to achieve the taper defining the funnel element or to achieve the concentration effect.

The funnel element is preferably mirror coated. There can thereby only be internal reflections and no light losses. Unlike the pure total reflection, this does not depend on the material and the reflection angle.

A deflection element is preferably arranged at an end of the funnel element disposed opposite the light guide plate. The deflection element particularly preferably provides a deflection in the direction of incidence of light, that is transverse and in particular almost perpendicular to the first main surface. In other words, the direction of propagation of the received light after the deflection element is that at which the received light would exit a conventional reception lens, but laterally offset by the extent of the light guide plate and the funnel element. The beam exiting at the deflection element will additionally have a considerably larger angle of emergence, but this widening has no further effect if the light receiver is seated directly there or close enough. The advantage of such a deflection element is that the light receiver can be oriented as in a conventional sensor with the plane of the light-sensitive surface in parallel with the first main surface. A circuit board on which the light receiver is arranged can thus be aligned in parallel with the main surface. The circuit board thus hardly takes up any construction depth since its surface extent does not relate to the construction depth. At the outlet of the funnel element, without a deflection element, the light receiver would have to be arranged transversely or substantially perpendicular to the first main surface, which would be an obstacle in achieving a small construction depth of the total sensor. A prism can, for example, be considered as a deflection element, alternatively a curved attachment piece of the funnel element. The deflection element can be mirror coated to improve the efficiency.

The deflection element preferably has beam shaping properties. Concentrating or focusing beam shaping properties are particularly advantageous to further reduce the cross-section of the received light on an impingement on the light receiver. For this purpose, a deflection element formed as a prism can have curved surfaces having a spherical curvature, an aspheric curvature, or a free-form shape.

The grating structure is preferably linear. This is a particularly simple diffractive structure that effects the desired deflection from the direction of incidence of light into the plane of the main surface with a suitable orientation. In an alternative preferred embodiment, the light guide plate has a non-linear grating structure as the diffractive structure to additionally defect the received light inwardly in the plane of the first main surface. Such a non-linear grating structure first satisfies the primary object of the deflection of the received light toward the lateral edge and thus toward the light receiver or toward the funnel element. In addition, however, the non-linear, for example curved, grating structure also provides a deflection within the plane in parallel with the first main surface. Such a non-linear grating structure is a little more complex to determine and to manufacture. However, it supports the concentration effect of the optical funnel element that can be correspondingly shorter or even replaces it.

The light guide plate preferably has at least two segments whose grating structures are differently aligned to additionally deflect the received light inwardly in the plane of the first main surface. The segments are divided by separating lines through the first main surface transversely to the lateral edge, that is they are a kind of strip whose narrow sides together form the lateral edge. Except for a possible central segment, the segments or at least their grating structures are inclined a little toward the center of the lateral edge. In a similar manner to a matching non-linear grating structure, a concentration effect thus already results in the light guide plate that supports or replaces the funnel element. The grating structures are here preferably linear; the inward deflection then only takes place, unlike with a non-linear grating structure, due to the different orientation. It is also conceivable to form segments and nevertheless to provide non-linear grating structures per segment. The concentration effects of the non-linear grating structure and of the inwardly oriented alignment of the respective grating structure then complement one another.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

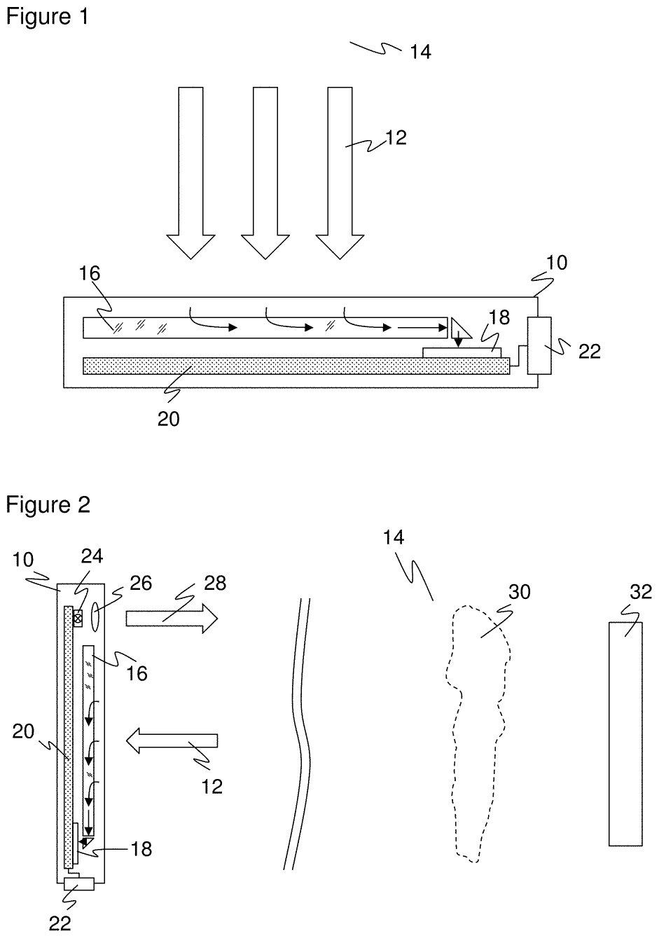

FIG. 1 a schematic view of an optoelectronic sensor with a flat plate collector as a reception optics;

FIG. 2 a schematic view of a further embodiment of an optoelectronic sensor as a light sensor or as a reflection light barrier;

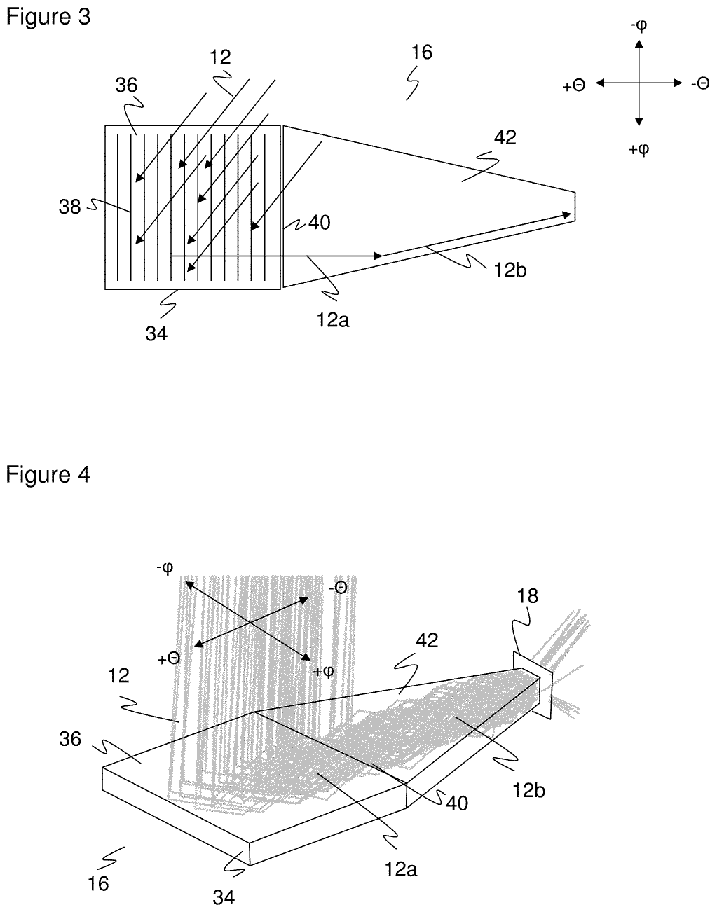

FIG. 3 a schematic plan view of a reception optics configured as a flat plate collector;

FIG. 4 a three-dimensional view of an exemplary beam extent in a reception optics in accordance with FIG. 3;

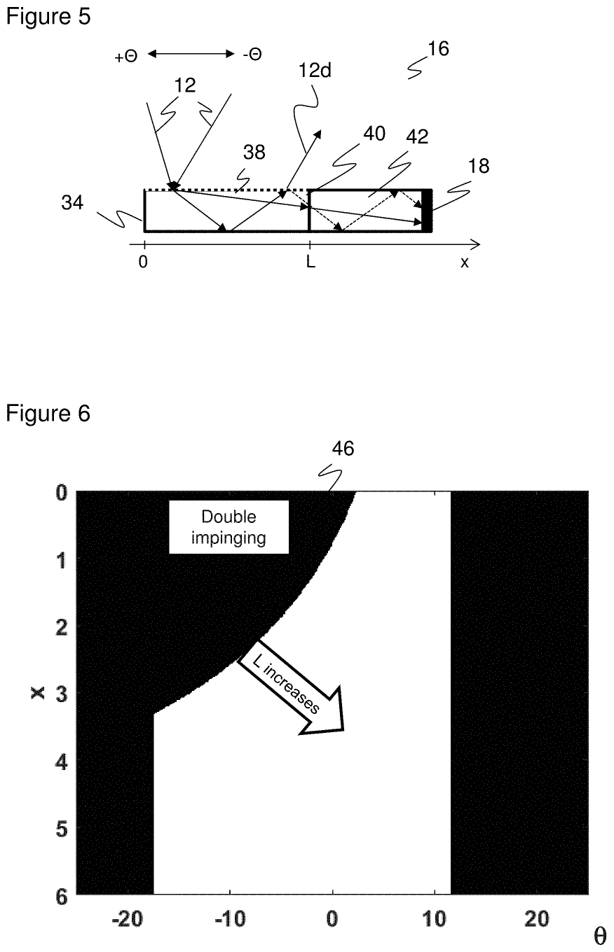

FIG. 5 a further representation of the beam extent in the reception optics to explain double impingements;

FIG. 6 a representation of which angles of incidence θ lead to a light reception at which lateral location X on the flat plate collector and which do not;

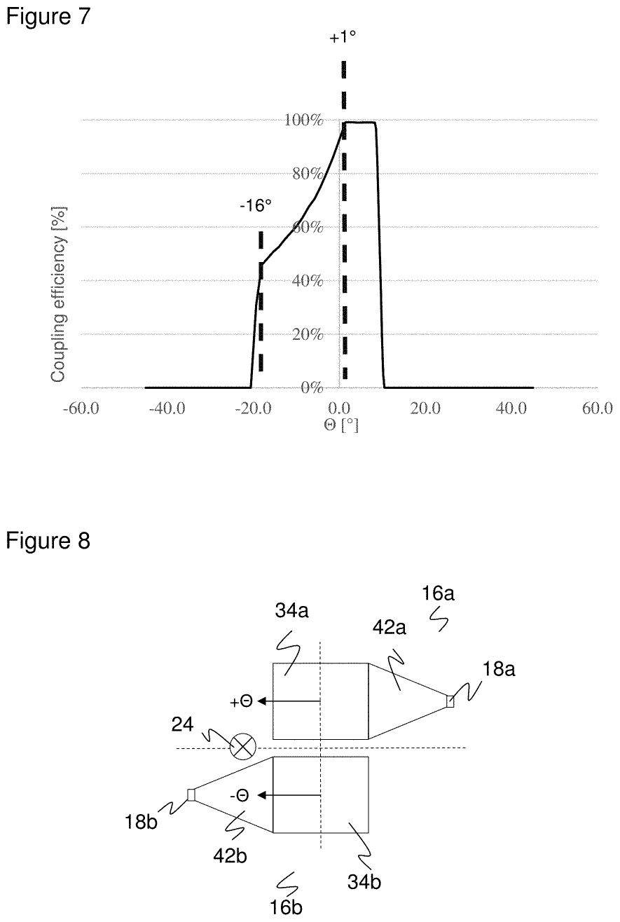

FIG. 7 a representation of the coupling efficiency of the flat plate collector in dependence on the angle of incidence θ;

FIG. 8 a representation of an arrangement of two flat plate collectors rotated by 180° with respect to one another for a distance measurement;

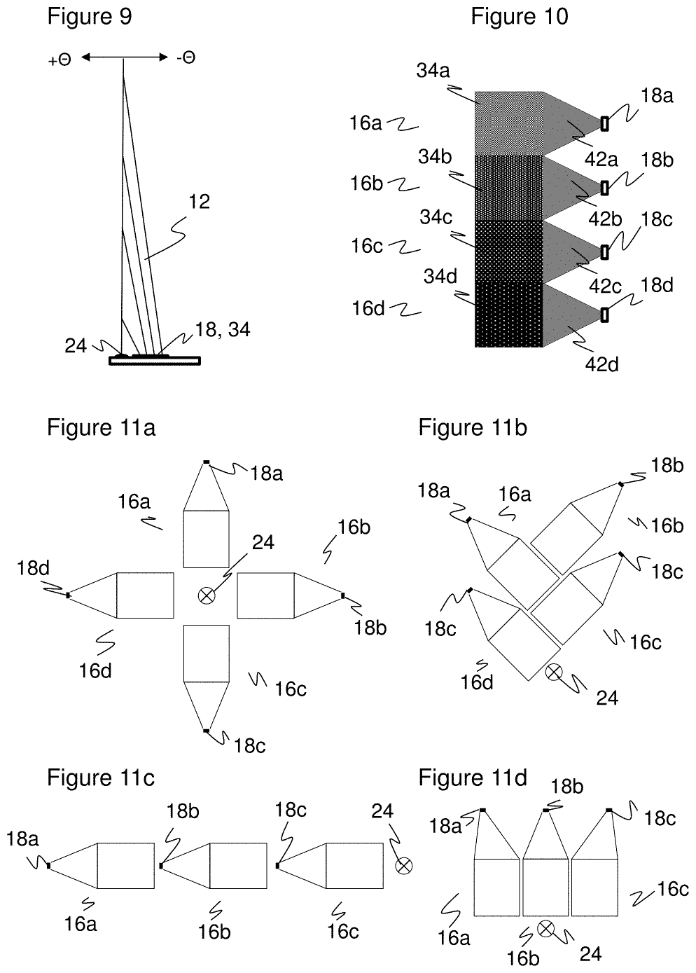

FIG. 9 a schematic representation of the point of impingement of the received light on a light receiver migrating in accordance with the triangulation principle;

FIG. 10 a spatially resolved light receiver built up of a plurality of flat plate collectors for distance measurement in accordance with the triangulation principle;

FIGS. 11a-d various arrangements of flat plate collectors rotated with respect to one another for a distance measurement in accordance with the triangulation principle;

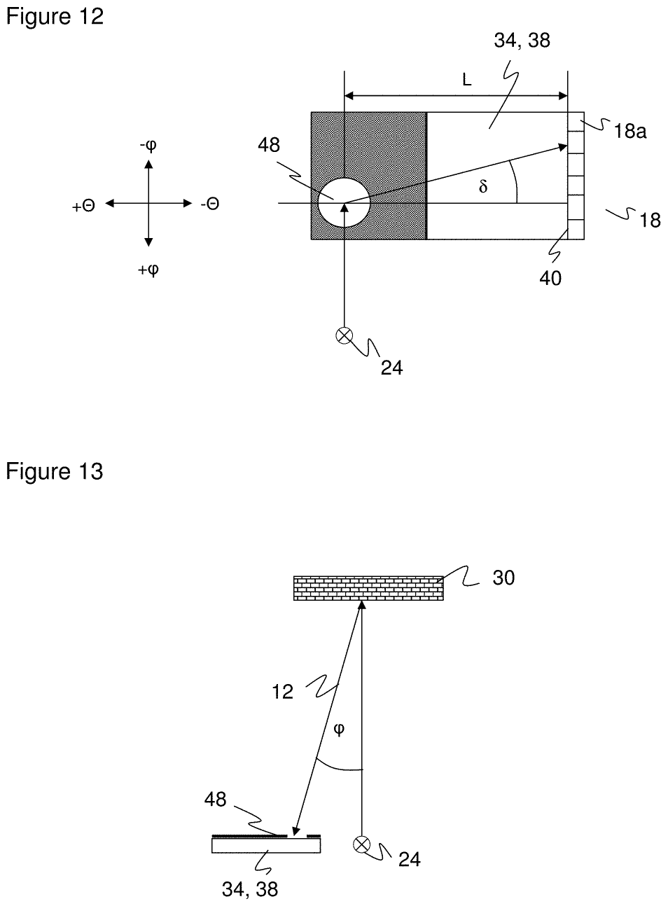

FIG. 12 a plan view of a flat plate collector to explain a distance measurement with only one flat plate collector with an arrangement of light transmitter to flat plate collector rotated by 90° to utilize a perpendicular angle component φ of the direction of incidence of the received light for a triangulation;

FIG. 13 a sketch for the explanation of the angle component φ;

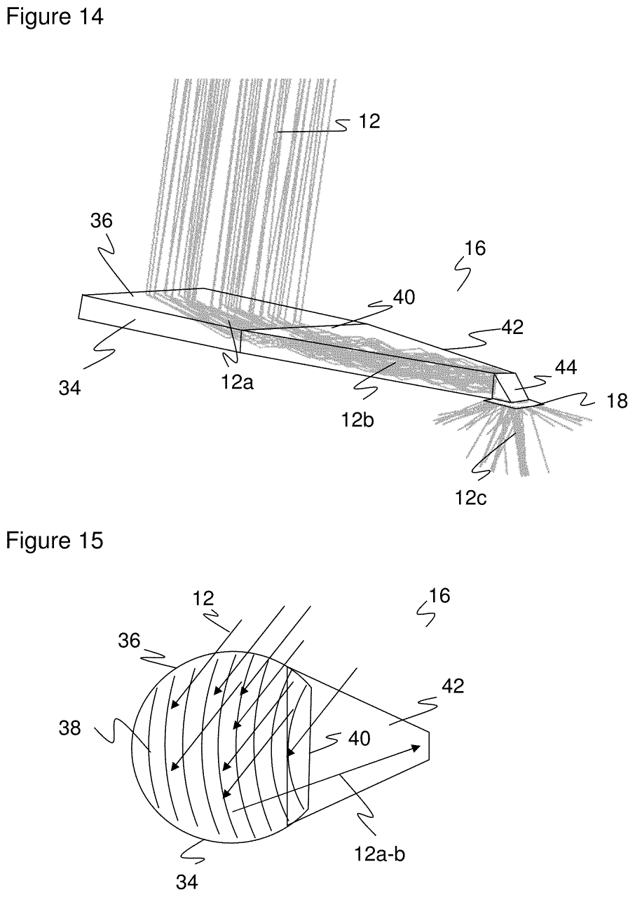

FIG. 14 a three-dimensional view similar to FIG. 4, but in a varied perspective and with a reception optics having an additional deflection element at the outlet side;

FIG. 15 a schematic plan view of a reception optics configured as a flat plate collector and with a non-linear grating structure;

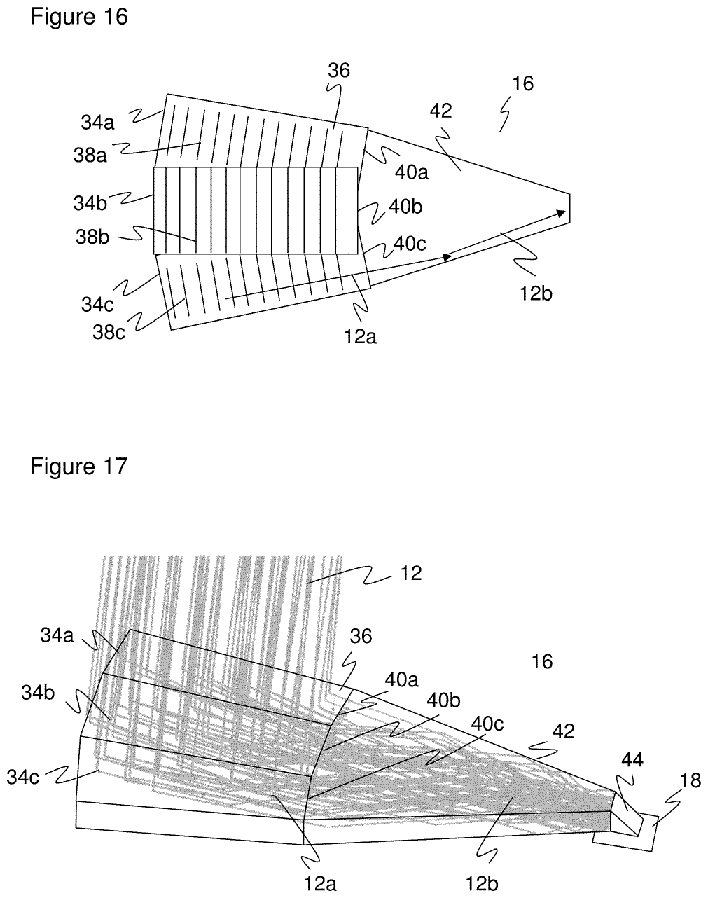

FIG. 16 a schematic plan view of a reception optics configured as a flat plate collector with a plurality of segments; and

FIG. 17 a three-dimensional view of an exemplary beam extent in a reception optics in accordance with FIG. 16.

FIG. 1 shows a schematic block diagram of an optoelectronic sensor 10. Received light 12 from a monitored zone 14 is incident on a flat reception optics 16 having a large aperture with a direction of incidence of light corresponding to the arrows to collect as much received light 12 as possible. The reception optics 16 initially deflects the received light 12 laterally and then a further time back into the direction of incidence of light before it is incident on a light receiver 18, The second deflection is optional; otherwise the light receiver 18 is oriented perpendicularly.

The reception optics 16 and its light deflection will be explained in more detail below in different embodiments with reference to FIGS. 3 to 17. Only its rough geometrical design is provisionally of interest, namely that it is particularly flat.

The light receiver 18 generates an electronic received signal from the incident received light 12, said electronic received signal being supplied to a control and evaluation unit 20. In FIG. 1, the control and evaluation unit 20 is only shown symbolically as a circuit board on which the light receiver 18 is also arranged. They are generally any desired analog and/or digital evaluation modules such as one or more analog circuits, microprocessors, FPGAs, or ASICs, with or without an analog preprocessing.

The parallel alignment of the reception optics 16, the light receiver 18, and the circuit board with the control and evaluation unit 20, on which other electronics can also be accommodated, permits a total structure of the optoelectronic sensor in the shown flat construction with an extremely small construction depth of only a few millimeters.

Due to the deflection, the control and evaluation unit 20 receives a summary intensity signal that is suitable for evaluations in which the light spot geometry or a piece of angular information of the incident received light 12 is not required. An example is a threshold value comparison to determine the presence of objects. Time of flight measurements are also conceivable provided that the demands on accuracy are not too high since in the millimeter range different light paths mix in the reception optics 16. The result of the evaluation, for example a switching signal corresponding to the binary object determination signal or a measured distance can be output at an interface 22.

The sensor 10 shown in FIG. 1 is passive, that is it receives received light 12 of any desired source. Instead, however, received light 12 from an associated light transmitter can also be received. In the case of a through beam sensor, the light transmitter is located on the oppositely disposed side of the monitored zone 14 and the control and evaluation unit 20 can recognize objects in the beam path by an intensity drop because they cover the light transmitter.

FIG. 2 shows a further embodiment of an optoelectronic sensor 10 having its own light transmitter 24 together with an associated transmission optics 26. The received light 12 is in this case its own transmission light 28 after it has been reflected back in the monitored zone 14. This is the principle of a light sensor that recognizes an object 30 when the transmitted light 28 is incident thereon and is remitted. However, it is also the functional principle of a reflection light barrier to which a cooperative reflector 32 belongs to which the transmitted light 28 is aligned. The control and evaluation unit 20 in this case expects the received light 12 reflected back by the reflector 32. If an object 30 moves in front of the reflector 32, the received level drops and the object 30 can be recognized thereby; for example again by a threshold value comparison. To distinguish its own transmitted light 28 from extraneous light and thus to make the switching behavior substantially more robust, two polarization filters can be arranged in the transmission and reception path whose direction of polarization is crossed in accordance with a polarization rotation of the reflector 32.

FIG. 3 shows a schematic plan view of the reception optics 16. The received light 12 is shown symbolically by a plurality of arrows whose direction of incidence is substantially perpendicular to the plane of the paper which can only be perspectively indicated.

The reception optics 16 has a flat light guide plate 34 or a flat plate collector. In a plan view, only the upper main surface 36 or a flat side of the flat light guide plate 34 can be recognized. In the depth direction perpendicular to the plane of the paper, the light guide plate 34 is very thin; its thickness is smaller by factors than the lateral extent of the main surface 36. The light guide plate 34 collects received light 12 with a very large aperture with the main surface 36.

A diffractive structure 38 on the light guide plate 34 provides a deflection of the received light 12 toward a lateral edge 40. The diffractive structure 38 can be upwardly arranged at the first main surface 36 and/or downwardly at the oppositely disposed flat side. After the deflection, received light 12a propagates in a new direction, to the right in FIG. 3, within the light guide plate 34, and is guided in total reflection in so doing. The lateral edge 40 is not necessarily only a single straight part piece, but can also be straight in parts with edge segments at an angle close to 180° with respect to one another or can be curved.

The diffractive structure 38 can in particular be an echelette grating (blazed grating). Such an echelette grating diffracts incident received light 12 of a defined wavelength by a very large amount and almost only in one specific order of diffraction. The diffraction is therefore chromatically selective, which simultaneously provides the advantage of an optical bandpass effect that can be matched to its own light transmitter 24. The diffraction is additionally very direction-specific due to the high maximum in an order of diffraction. A new preferred direction of the bundle of beams toward the lateral edge 40 is thereby produced at such flat angles that the deflected received light 12a remains in the light guide plate 34 due to total reflection. No received light 12 is diffracted in the direction of the further edges of the light guide plate 34 so that nothing is lost there either. It would, however, also be possible to apply a mirror coating here.

At least one component of the received light 12 is incident on the plane of the paper on the reception optics 16 along the normal. The differences from the normal are described here and in the following using two angles θ and φ. Since they relate to said normal, both angles θ, φ are measured in a first and second plane perpendicular to the main surface of the reception optics 16 or in FIG. 3 the plane of the paper. The first plane of the angle θ additionally comprises the main direction of deflection of the deflected received light 12 toward the lateral edge 40 and is a horizontal plane perpendicular to the plane of the paper in FIG. 3. The second plane of the angle φ is perpendicular to the first plane and is a vertical plane perpendicular to the plane of the paper in FIG. 3.

Optionally, a second light collecting or light concentrating function adjoins the coupling into the light guide plate 34 by the diffractive structure 38 and thus the deflection in the light guide plate 34 to the lateral edge 40. For this purpose, an optical funnel element 42 is preferably arranged at the lateral edge 40. The optical funnel element 42 is an element that tapers in the cross-section and that generates the received light 12b concentrated in a transverse direction of the funnel element 42 in parallel with the extent of the lateral edge 40.

The beam extent in the reception optics 16 becomes better understandable by a simulated example that is show in a three-dimensional view in FIG. 4. The two angles θ and φ are again also drawn here by which the respective direction of incidence can be described. The received roughly perpendicular incident light 12 with the differences in θ and φ is diffracted at the upper side or lower side by the diffractive structure 38 and is conducted as deflected received light 12a to the lateral edge 40. It becomes concentrated received light 12b in the optical funnel element 42 that is incident on the light receiver 18 arranged at a beam exit point of the funnel element 42.

The received light 12 is thus concentrated in both cross-sectional directions. The extent is limited in the vertical direction by the small thickness of the light guide plate 34 that continues in the optical funnel element 42 or that is even further reduced there. The focusing effect or concentration effect comes into force in the width direction, in parallel with the lateral edge, due to the cross-section reducing geometry of the optical funnel element 42. Both axes satisfy the condition of the waveguide-led total reflection. The light guide plate 34 and the optical funnel element 42 are manufactured from suitable transparent plastic such as PMMA or PC. Mirror coatings can be applied to support the total reflection.

The optical funnel element 42 is preferably equally of a flat design like the light guide plate 34 and thus directly adjoins the shape of the lateral edge 40. It is possible to configure both in one piece. To further optimize the beam shaping in the optical funnel element 42, the taper can also have a parabolic or a different tapering cross-sectional extent.

It has been explained that the light guide plate 34 and the optional funnel element collect the received light 12 and the light receiver accordingly only produces a common received signal. In accordance with the invention, however, a distance should be measured by a triangulation principle and a distinction should be made for this purpose between different angles of incidence. The light receiver 18 is therefore first configured as spatially resolving, i.e. from a plurality of discrete light receivers, for example photodiodes, as a PSD (position sensitive device) or as an integrated reception pixel arrangement, for instance in the form of a receiver array. This alone would, however, not yet lead to the objective since the received light 12b arriving at the light receiver 18 no longer includes the desired spatial information at all due to the light collecting properties of the reception optics 16. To understand the different embodiments with which a spatially resolved detection and thus a kind of triangulation is nevertheless achieved, the light guidance in the light guide plate 34 should first be described even more exactly with reference to FIGS. 5 to 7.

For this purpose, FIG. 5 first again shows a longitudinal sectional view of the coupling of received light 12 into the reception optics 16 and of the beam extents therein. The received light 12 is incident onto the diffractive structure 38, that has a length L, at the angle θ and is diffracted in the direction toward the light receiver 18. For this purpose, an order of diffraction different from zero is used, typically the first order of diffraction, with the diffractive structure 38 preferably being optimized such that practically all the received light 12 is diffracted in this order of diffraction. Practically no received light 12 reaches the light receiver 18 any more for angles θ that are too large outside the acceptance angle range. Depending on the point of impingement, the angle θ, the length L, and the configuration of the diffractive structure 38, it may occur that an incident light beam 12 impinges on the diffractive structure twice, a so-called double impingement. This is shown for the light beam 12 in FIG. 5.

Such light beams 12d are decoupled to a large extent and a substantial portion is lost for the detection since the portion reflected at the diffractive structure on a double impingement is considerably weakened.

FIG. 6 is a compact representation of the coupling and guidance properties of the light guide plate 36 without a funnel element 42. The angle of incidence θ is entered on the X axis, the lateral point of impingement X of the received light 12 on the light guide plate 34 on the Y axis, see also FIG. 5 again for the definition of θ and X. Black regions of the parameter space shown stand for no light guidance or for only a greatly weakened light guidance up to the light receiver 18; conversely, white regions stand for a high coupling onto the light receiver 18.

The two black strips to the left and right correspond to a non-adapted angle of incidence θ: either the condition for total reflection is no longer satisfied in the left region after the deflection so that the received light 12 is not guided in the light guide plate 34 or a diffraction only takes place grazingly or no longer at all in the right region. This acceptance region can be varied by properties of the diffractive structure 38, in particular its period, the wavelength of the received light 12, and the refractive index of the material of the light guide plate 34.

The circle-segment like double impingement region 46 is determined by the position of impingement and thus by the macroscopic geometry of the light guide plate 34 and of the arrangement in the sensor 10. This region in particular grows as the length L of the diffractive structure increases and vice versa. It is of particular interest that the double impingement region 46 is practically only at a negative θ. This produces asymmetry in the coupling efficiency at a θ of the same amount, but of a different sign that should be examined more exactly next.

For this purpose, the coupling efficiency is entered in FIG. 7 in dependence on θ for an exemplary light guide plate 34 having a diffractive structure 38 with a grating of the period 500 nm and a length L=5 mm as well as a funnel element 42 of 10 mm in length. The shown angle-dependent coupling function is only an example; it can be influenced by the design of the diffractive structure 38 and of the construction of the light guide plate 34.

In a simple model of an angle-selective diffractive structure 38 such as a blazed grating, a symmetrical arrangement would have to be expected here in which the coupling efficiency drops abruptly at both sides from a specific angle θ onward. In fact, however, a very shallow flank that starts at approximately −16° and even still reaches into the positive range at +1° is shown for negative angles θ. This can be utilized as a kind of working region of non-constant coupling efficiency to measure the angle of incidence and so to triangulate a distance.

FIG. 8 for this purpose shows as a possible embodiment a plan view of an arrangement of two partial reception optics 16a-b each having a light guide plate 34a-b and an optional funnel element 42a-b. They each collect the received light 12 on a light reception element 18a-b of their own. The two light reception elements 18a-b together form a spatially resolved light receiver 18 since the received signals of the light reception elements 18a-b are distinguished. Alternative arrangements of partial reception optics 16a-b and light reception elements 18a-b will be explained later with reference to FIGS. 11a-d.

As seen at FIG. 7, the coupling efficiency is asymmetrical with respect to the angle θ, with this asymmetry being a direct consequence of the double impingement or of the double impingement region 46. The two partial reception optics 16a-b therefore produce different received signals with light incident from a specific angle θ. A conclusion on the angle θ can therefore be drawn from a comparison of the two received signals S1 and S2 of the light reception elements 18a-b. The difference S1−S2 is formed, for example, or for independence from the total level, preferably the signal contrast (S1−S2)/(S1−S2). The two received signals S1 and S2 can be called near signals and far signals because the angle θ depends on the distance of the detected object that reflects the received light 12.

Alternatively or additionally to the described utilization of the asymmetry of the coupling efficiency, it is also conceivable to use a plurality of diffractive structures 38 having different acceptance angles and thereby to sort the different possible angles of incidence θ through a plurality of partial reception optics to different light reception elements.

For this purpose, FIG. 9 first again sown how the angle of incidence θ differs with the object distance. The received light 12 therefore impinges at a different angle of incidence θ in dependence on the object distance and the received light spot migrates on the light guide plate 34.

FIG. 10 shows an arrangement of a plurality of partial reception optics 16a-d each having an associated light reception element 18a-d to evaluate the different reception angles θ. The light reception elements 18a-d can be discrete elements, but also regions of a pixel-resolved light receiver that together as a spatially resolved light receiver 18 produce four received signals.

The respective diffractive structures 38 of the light guide plates 34a-d are adapted to a specific and different angular range θ of their respective own. As can be recognized in FIG. 9, this corresponds to a respective distance region.

Each part structure 16a-d, 18a-d is accordingly responsible for a part interval of the distance region to be detected in total. The part intervals complement one another, preferably also with a certain overlap. The part structures 16a-d, 18a-d are thus near and distance zones or corresponding central zones.

The shown number of four part structures 16a-d, 18a-d is purely exemplary as is their arrangement next to one another. FIGS. 11a-d show a plurality of variations that are still by no means exclusive and that are suitable for embodiments with a utilization of the asymmetry of the coupling efficiency, as explained with respect to FIG. 8, and/or for distance dependent responsibilities of the respective diffractive structure 38, as just explained with respect to FIGS. 9 and 10. Although no different diffractive structure 38 is indicated by pattern fillings, as in FIG. 10, the part structures in FIGS. 11a-d can each be adapted to specific mutually complementing angular ranges θ.

FIG. 11a shows an arrangement of four part structures 16a-d, 18a-d arranged in star shape. In this respect, in particular two respective part structures 16a, c; b, d are, as in FIG. 8, rotated by 180° with respect to one another. FIG. 11b shows a further arrangement of four part structures 16a-d, 18a-d in a more compact arrangement and a pairwise rotation by 90°. In FIG. 11c, three part structures 16a-c, 18a-c are arranged behind one another instead of next to one another as in FIG. 10. In FIG. 11d, three part structures 16a-c, 18a-c are in turn arranged next to one another, but due to a corresponding shape of the funnel elements 42a-c, the distance between the light reception elements 18a-c varies, which can facilitate the real design of the light receiver 18.

In the previous embodiments, the distinguishing of the angles of incidence was achieved in that a plurality of light guide plates 34 each having a simple light reception element were used that were each responsible for specific angles of incidence. It is, however, also possible to distinguish angles of incidence with only one light guide plate 34 and its diffractive structure.

FIG. 12 shows a plan view of a light guide plate 34 or of its diffractive structure 34. The spatially resolving light receiver 18 is arranged at the lateral edge 40. So that a localizable received light spot is produced at all, a diaphragm 48 is arranged on the main surface 36 of the light guide plate 34.

In contrast to the previous embodiments, the total light deflected by the light guide plate 34 is not deflected by only one light reception element and converted into a summary received signal. A distinction is rather made by the spatially resolving light receiver 18 where received light 12 is incident on the lateral edge 40. A plurality of discrete or pixel-like light reception elements 18a are associated with the same light guide plate 34 or with the diffractive structure 38. A PSD can alternatively be used. The optional funnel element 42 is dispensed with.

The angle θ was previously used for the distance measurement. Here it is now the angle φ perpendicular thereto. Both angles θ, φ were already introduced with respect to FIGS. 3 and 4 and are drawn again in FIG. 12. The previous implicit assumption was that the decoupling at φ is symmetrical and the angle φ was therefore neglected. The diffractive structure 38, however, is not only effective in the direction of the angle θ where an almost complete deflection takes place when the narrow acceptance angle range is maintained. The diffractive structure 34 acts almost as a mirror in the direction of the angle φ. Received light 12 is therefore deflected in the direction of the lateral edge 40 and there impinges on a specific point in dependence on the angle φ. The angular range for φ in which this works with a good coupling efficiency is particularly large when θ includes the ideal acceptance angle.

In the shown arrangement of the light transmitter 24, the received light 12 impinges at a different angle φ in dependence on the detected object. The point of impingement migrates due to the effective effect of the diffractive structure 38 on this angular component φ similar to a mirror in the representation in a vertical direction.

This is shown again from a different perspective in FIG. 13. The representation of FIG. 12 is rotated counterclockwise by 90° and is then again rotated by 90° to the rear into the plane of the paper. The light receiver 18 can thereby not be recognized; it is behind the light guide plate 34. The point of impingement migrates from left to right in accordance with the varying angle φ.

In order therefore to be able to measure using the angle φ, the light transmitter 24 is, as shown, to be offset in the direction corresponding to φ with respect to the light guide plate 34. The light transmitter 24 therefore has is triangulation offset in the direction of the lateral edge 40. The additional lateral offset serves the purpose that the different angle θ corresponds to the optimum acceptance angle. The angle θ does not vary here, however, but is rather fixed by the design, and indeed preferably to the ideal acceptance angle θ=0 so that a large angular range having good coupling efficiency is achieved for the angle φ.

With a suitable arrangement of the light transmitter 24, the angle φ varying with the distance is converted into an angle δ after the deflection. This in turn leads to a specific point of impingement on the spatially resolving light receiver 18. As can be seen, the offset on the spatially resolving light receiver 18 additionally relates linearly to the distance L, that is to the lateral extent of the light guide plate 34 if it is assumed that the aperture of the diaphragm 48 is respectively arranged at the outer margin. The sensitivity of the sensor 10 can thus be defined by this length L in a similar manner to the focal length of the lens with a conventional triangulation. With a larger L, a specific δ leads to a larger offset on the light receiver 18; the distance measurement therefore becomes more sensitive, and vice versa.

A distance measurement can take place with only one single light guide plate 34 or diffractive structure 38 using this embodiment. It is nevertheless also conceivable to combine this with the other embodiments and thereby, for example, to divide the total range to be covered in part portions, with now distances not only being able to be associated in a class-like manner, but also being able to be measured in each part portion with the embodiment in accordance with FIGS. 12 and 13.

All the embodiments described can be supplemented by further optical elements. For example, further angle filters and frequency filters can be affixed in front of the diffractive structure 38. Further variations will now be explained.

FIG. 14 again shows a three-dimensional view of an exemplary beam extent in a reception optics 16. Unlike FIG. 4, the light receiver 18 itself is not already located at the beam exit side of the funnel element 42, but a further deflection element 44 is rather first arranged therebetween for the light coupling into the light receiver 18. The exiting received light 12c thereby practically again returns to the original direction of incidence of light, only laterally offset and widened by the extent of the reception optics 16, which does not, however, play any role in the proximity of the light receiver 18. Due to the direction of incidence of light, the light receiver 18 can be aligned in parallel with the main surface 36 and this enables the particularly flat arrangement shown in FIG. 1 having a circuit board of the control and evaluation unit 20 in parallel with the reception optics 16.

The deflection element 44 is designed as a deflection prism in FIG. 14. The prism can have planar surfaces or can additionally have a light focusing shape, for instance with spherically or aspherically curved surfaces or with a free-form surface. The prism, like the optical funnel element 42, can be at least partly mirror coated to reduce decoupling losses, in particular at the end of the optical funnel element. Alternatively to a separate deflection element 44, it is also conceivable to configure the optical funnel element 42 with a kind of downwardly directed continuation, preferably with a mirror coating that satisfies this function. The light guide plate 34, the funnel element 42 and/or the deflection element 44 can be formed in one piece.

FIG. 15 shows a plan view of a further embodiment of the reception optics 16. in the previous embodiment, for instance in accordance with FIG. 3, the diffractive structure 38 is configured as a linear grating arrangement. A pure deflection and a concentration only in the depth direction of the light guide plate 34 accordingly take place. The concentration in the second lateral axis only takes place in the optical funnel element 42 there.

In the embodiment in accordance with FIG. 15, a non-linear grating arrangement is instead provided as the diffractive structure. The received light 12 is thereby already immediately concentrated in both axes. The funnel element 42 can accordingly be shorter or even be completely omitted.

FIG. 16 shows a plan view of a further embodiment of the reception optics 16. The light guide plate 34 is here divided into at least two segments 34a-c that are approximately of cross-strip type and divide the lateral edge 40 accordingly. The number of segments is initially not limited. The segments 34a, c are slightly inwardly tilted, with the exception of the central segment 34b. Strictly speaking, this is only relevant to the linear grating arrangement 38a, c thereon.

A certain concentration also already takes place in a lateral direction due to the segmented arrangement of linear grating arrangements 38a-c. The segmentation is therefore an alternative to a non-linear grating arrangement in accordance with FIG. 15 to manage with a shorter funnel element 42 or even completely without the funnel element 42. A segmentation in accordance with

FIG. 16 can, however, also be combined with non-linear grating structures in accordance with FIG. 15.

FIG. 17 illustrates an exemplary optical path in a reception optics 16 having a segmented light guide plate 34a-c as in FIG. 16 in a three-dimensional view. An angle of ±9° was here selected as the setting angle of the outer segments 34a, c. The surface at the inlet, that is in the main surface 36, amounts to 4 mm*4.2 mm; at the outlet in front of the light receiver 18, the surface amounts to 1.2 mm*1.2 mm. A coupling efficiency of the total reception optics 16 of 56% can thus be achieved overall with a partially mirror-coated deflection prism 44.

A reception aperture of 25 mm² and more is, for example, achieved with a diffractive flat plate collector in accordance with the invention with a construction depth of only 1 mm. Larger reception apertures of, for example, 6 mm*8 mm are also possible. The signal gain thus increases by an order of magnitude; the range of the sensor can be increased by factors of two, three, and more. There are in this respect extremely small construction depths of, for example, only 3.5 mm that would only permit a conventional aperture of 1.5 mm. In accordance with the invention, these 1.5 mm are available for the thickness of the flat reception optics 16 that, however, provides an immeasurably larger surface with edge lengths that exceed the thickness by a factor of two, three, and more in both directions.

1. An optoelectronic sensor for detecting objects in a monitored zone, the optoelectronic sensor comprising
a light receiver having a reception optics arranged in front of it for generating a received signal from received light that impinges the optoelectronic sensor in a direction of incidence of light from the monitored zone, wherein the reception optics comprises a flat light guide plate having a first main surface and a lateral edge bounding the first main surface at a side; wherein the first main surface of the light guide plate is arranged transversely to the direction of incidence of light and has a diffractive structure to deflect the incident received light to the lateral edge; and
a control and evaluation unit to evaluate the received signal, wherein the light receiver is spatially resolving; and wherein the control and evaluation unit is configured to acquire a piece of distance information of a detected object from the point of impingement of the received light on the light receiver.

2. The optoelectronic sensor in accordance with claim 1, wherein the optoelectronic sensor is one of a light barrier and a light sensor.

3. The optoelectronic optoelectronic sensor in accordance with claim 1, that is configured as a background masking light sensor in which the light receiver has a near zone and a far zone and that has a switching outlet whose switching state depends on whether an object is detected in the near zone.

4. The optoelectronic optoelectronic sensor in accordance with claim 1, that is configured as a triangulation sensor in which the control and evaluation unit measures the distance of the detected object from the point of impingement of the received light on the light receiver.

5. The optoelectronic sensor in accordance with claim 1,
that has a light transmitter in a triangulation arrangement with respect to the light guide plate.

6. The optoelectronic sensor in accordance with claim 1,
wherein the diffractive structure has a grating structure.

7. The optoelectronic sensor in accordance with claim 6,
wherein the grating structure is one of a blazed grating and an echelette grating.

8. The optoelectronic sensor in accordance with claim 1,
wherein the reception optics has a plurality of flat light guide plates at whose lateral edges a respective light reception element of the light receiver is arranged.

9. The optoelectronic sensor in accordance with claim 8,
wherein the light guide plates are arranged rotated with respect to one another with respect to a normal on their main surfaces.

10. The optoelectronic sensor in accordance with claim 9,
wherein two light guide plates are arranged rotated with respect to one another by 180° with respect to a normal on their main surfaces.

11. The optoelectronic sensor in accordance with claim 10,
wherein the control and evaluation unit is configured to determine the piece of distance information from a difference of the first received signal of the light reception element associated with the first light guide plate and of the second received signal of the light receiver element associated with the second light guide plate.

12. The optoelectronic sensor in accordance with claim 11,
wherein the control and evaluation unit is configured to determine the piece of distance information from the quotient of the difference and sum of the first received signal and the second received signal.

13. The optoelectronic sensor in accordance with claim 8,
wherein the diffractive structures of the light guide plates are configured to deflect respective received light having a direction of incidence of light of an acceptance angle range, with the acceptance angle ranges of the light guide plates being different.

14. The optoelectronic sensor in accordance with claim 1,
wherein the light receiver is configured to determine the point of impingement of the received light at the lateral edge of a light guide plate.

15. The optoelectronic sensor in accordance with claim 14,
wherein only one single light guide plate is provided.

16. The optoelectronic sensor in accordance with claim 14,
wherein a diaphragm is arranged in front of the main surface.

17. The optoelectronic sensor in accordance with claim 14,
wherein the light transmitter is arranged with respect to the light guide plate such that the direction of incidence of light varies with the distance of the detected object at an angle transversely to the direction of the lateral edge.

18. The optoelectronic sensor in accordance with claim 17,
wherein the light transmitter is arranged with respect to the light guide plate such that the direction of incidence of light is in an acceptance angle range of the diffractive structure.

19. A method of detecting objects in a monitored zone in which a light receiver having a reception optics arranged in front of it generates a received signal from received light incident with a direction of incidence of light, wherein the received light impinges transversely on a first main surface of a flat light guide plate of the reception optics and is deflected in the flat light guide plate by means of a diffractive structure to a lateral edge bounding the first main surface,
wherein the light receiver is spatially resolving; and wherein a piece of distance information of a detected object is acquired from the received signal in accordance with the point of impingement of the received light on the light receiver.
